(19) United States
(12) Patent Application Publication
(10) Pub. No.: US 2026/0268558 A1
(43) Pub. Date: Sep. 10, 2026

(54) DISPLAY DEVICE AND IMAGE SETTING OPTIMIZATION METHOD FOR DISPLAY DEVICE

(71) Applicant: HISENSE VISUAL TECHNOLOGY CO., LTD., Qingdao (CN)

(72) Inventors: Jiayu LIU, Qingdao (CN); Xiaoming SHAO, Qingdao (CN); Yanqing RU, Qingdao (CN)

(21) Appl. No.: 19/660,735

(22) Filed: Apr. 28, 2026

Related U.S. Application Data
(63) Continuation of application No. PCT/CN2024/112871, filed on Aug. 16, 2024.

(30) Foreign Application Priority Data
Oct. 31, 2023 (CN) 202311433518.X
Oct. 31, 2023 (CN) 202311433524.5

(51) Int. Cl. G06T 11/60; G06F 3/0482; G06F 3/04845

(52) U.S. Cl. CPC G06T 11/60; G06F 3/0482; G06F 3/04845

(57) ABSTRACT

The present application relates to a display device and an image setting optimization method for the display device. The method can include: in response to a startup instruction for displaying a first image setting page, displaying the first image setting page, and monitoring a click event of the first image setting page; in response to the click event input by a target menu item in the first image setting page, measuring menu item parameters of the target menu item; when the menu item parameters include identification parameters of a second image setting page, querying title parameters of the target menu item, and controlling a display to display the second image setting page; then, on the basis of the target menu item of the second image setting page, modifying image parameters.

### CROSS-REFERENCE TO RELATED APPLICATIONS

The present application is a continuation application of PCT/CN2024/112871 filed on August 16, 2024, which claims priority to Chinese Patent Application No. 202311433524.5, filed on October 31, 2023, and Chinese Patent Application No. 202311433518.X, filed on October 31, 2023, the entire contents of all of which are incorporated herein by reference.

### TECHNICAL FIELD

The present disclosure relates to the technical field of display devices, and in particular, to a display device and a method for optimizing image settings for a display device.

### BACKGROUND

A display device refers to a terminal device capable of outputting a specific display screen, which may be a smart TV, a communication terminal, a smart advertising screen, a projector, or other terminal devices. Taking a smart TV as an example, a smart TV is a television product based on Internet application technology, featuring an open operating system and chip, having an open application platform, enabling bidirectional human-computer interaction functions, and integrating functions such as video, audio, entertainment, and data, to meet users’ diverse and personalized needs.

A display device can adjust parameters of a playback picture, such as picture quality, brightness, color, and sharpness, through an image settings page. For example, the image settings page may include a picture mode setting, the picture mode setting is a comprehensive setting item in the image settings, and may be associated with a plurality of image parameters, i.e., a plurality of image parameters can be modified simultaneously through the picture mode setting. To improve the user’s viewing experience, the user can also adjust the image parameters of the picture through the image settings page when the display device plays media pictures of different sources or pictures from an external device.

However, the image settings page may obscure the playback picture of the display device, making it impossible for the user to observe real-time changes in the picture while adjusting the image parameters. The user needs to repeatedly switch between the image settings page and the playback picture, which prolongs the image setting time, thereby reducing the processing efficiency of image settings and deteriorating user experience.

### SUMMARY

According to some embodiments of the present disclosure, a display device includes a display, a memory, and at least one processor. The display is configured to display a playback picture. The memory is configured to store computer instructions and data associated with the display device. The at least one processor is configured to execute the computer instructions to cause the display device to: in response to a startup command sent by a user for displaying a first image settings page, control the display to display the first image settings page, wherein the first image settings page includes menu items, and a display priority of the first image settings page is higher than a display priority of the playback picture; monitor click events for the first image settings page; in response to a click event generated by a target menu item on the first image settings page, detect menu item parameters of the target menu item; when the menu item parameters include a target parameter, query a title parameter of the target menu item, wherein the target parameter is an identification parameter of a second image settings page, the second image settings page includes a display content of the target menu item, and a display priority of the second image settings page is higher than the display priority of the playback picture; control the display to display the second image settings page in accordance with the title parameter; and modify image parameters based on the target menu item on the second image settings page.

According to some embodiments of the present disclosure, a method for optimizing image settings for a display device, wherein the display device includes a display configured to display a playback picture, and the method includes: in response to a startup command sent by a user for displaying a first image settings page, controlling the display to display the first image settings page, wherein the first image settings page includes menu items, and a display priority of the first image settings page is higher than a display priority of the playback picture; monitoring click events for the first image settings page; in response to a click event generated by a target menu item on the first image settings page, detecting menu item parameters of the target menu item; when the menu item parameters include a target parameter, querying a title parameter of the target menu item, wherein the target parameter is an identification parameter of a second image settings page, the second image settings page includes a display content of the target menu item, and a display priority of the second image settings page is higher than the display priority of the playback picture; controlling the display to display the second image settings page in accordance with the title parameter; and modifying image parameters based on the target menu item on the second image settings page.

### BRIEF DESCRIPTION OF FIGURES

FIG. 1 is a schematic diagram of an operating scenario between a display device and a control apparatus according to some embodiments of the present disclosure.

FIG. 2 is a hardware configuration block diagram of the display device according to some embodiments of the present disclosure.

FIG. 3 is a hardware configuration block diagram of the control apparatus according to some embodiments of the present disclosure.

FIG. 4 is a schematic diagram of a software configuration in the display device according to some embodiments of the present disclosure.

FIG. 5 is a display effect diagram of an image settings page according to some embodiments of the present disclosure.

FIG. 6 is a schematic diagram of software logic processing for refreshing the image settings page according to some embodiments of the present disclosure.

FIG. 7 is a first schematic flowchart of the display device executing a method for optimizing image settings according to some embodiments of the present disclosure.

FIG. 8 is a schematic flowchart of a method for optimizing image settings according to some embodiments of the present disclosure.

FIG. 9 is a schematic diagram of an effect of a menu item in an enabled state according to some embodiments of the present disclosure.

FIG. 10 is a schematic diagram of an effect of a menu item in a disabled state according to some embodiments of the present disclosure.

FIG. 11 is a schematic flowchart of detecting an enabled attribute of a target menu item according to some embodiments of the present disclosure.

FIG. 12 is a schematic diagram of an effect of displaying prompt information on a first image settings page according to some embodiments of the present disclosure.

FIG. 13 is a schematic diagram of an effect of a second image settings page according to some embodiments of the present disclosure.

FIG. 14 is a timing diagram of interaction between the first image settings page and the second image settings page according to some embodiments of the present disclosure.

FIG. 15 is a schematic flowchart of switching sub-options of a menu item according to some embodiments of the present disclosure.

FIG. 16 is a second schematic flowchart of a display device executing a method for optimizing image settings according to some embodiments of the present disclosure.

FIG. 17 is a schematic flowchart of another method for optimizing image settings according to some embodiments of the present disclosure.

FIG. 18 is a schematic flowchart of setting a first input cycle according to some embodiments of the present disclosure.

FIG. 19 is a schematic flowchart of modifying a picture mode according to some embodiments of the present disclosure.

FIG. 20 is a schematic diagram of an effect of a target image settings page in one picture mode according to some embodiments of the present disclosure.

FIG. 21 is a schematic diagram of an effect after refreshing a target image settings page according to some embodiments of the present disclosure.

FIG. 22 is a schematic diagram of an effect of a target image settings page in another picture mode according to some embodiments of the present disclosure.

FIG. 23 is a schematic diagram of an effect of a target image settings page when a media type changes according to some embodiments of the present disclosure.

FIG. 24 is a schematic flowchart of refreshing an image settings page in accordance with a state flag according to some embodiments of the present disclosure.

FIG. 25 is a timing diagram of refreshing a target image settings page according to some embodiments of the present disclosure.

FIG. 26 is a schematic diagram of software logic processing for refreshing a target image settings page according to some embodiments of the present disclosure.

FIG. 27 is a schematic diagram of an effect of a prompt control according to some embodiments of the present disclosure.

FIG. 28 is a schematic diagram of an effect of displaying prompt information on a second image settings page according to some embodiments of the present disclosure.

### DETAILED DESCRIPTION

Embodiments will be described in detail below, examples of which are illustrated in the accompanying drawings. When the following description refers to the accompanying drawings, the same numbers in different drawings represent the same or similar elements unless otherwise indicated. The implementations described in the following embodiments do not represent all implementations consistent with the present disclosure. They are merely examples of systems and methods consistent with some aspects of the present disclosure as detailed in the claims.

It should be noted that the brief description of terms in the present disclosure is only for the convenience of understanding the implementations described below, and is not intended to limit the implementations of the present disclosure. Unless otherwise stated, these terms should be understood according to their ordinary and usual meanings.

The terms “first”, “second”, “third”, etc., in the specification and claims of the present disclosure and the above-mentioned drawings are used to distinguish similar or same objects or entities, and do not necessarily imply a specific order or sequence, unless otherwise noted. It should be understood that the terms used in this way are interchangeable under appropriate circumstances.

The terms “include” and “having” and any variations thereof are intended to cover non-exclusive inclusion. For example, a product or device that includes a series of components is not necessarily limited to those components explicitly listed, but may include other components not expressly listed or inherent to such product or device.

The term “module” refers to any known or later developed hardware, software, firmware, artificial intelligence, fuzzy logic, or combination of hardware or/and software code capable of performing the function associated with the element.

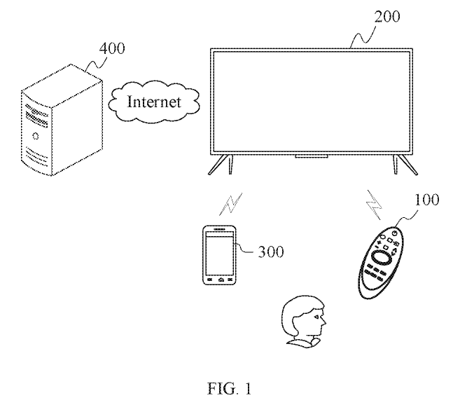

FIG. 1 is a schematic diagram of an operating scenario between a display device and a control apparatus according to some embodiments of the present disclosure. As shown in FIG. 1, a user can operate a display device 200 through a mobile terminal 300 and a control apparatus 100.

In some embodiments, the mobile terminal 300 and the display device 200 may have software applications installed, and achieve connection communication through a network communication protocol to achieve the purpose of one-to-one control operation and data communication. The audio and video content displayed on the mobile terminal 300 may also be transmitted to the display device 200 to achieve a synchronous display function.

As also shown in FIG. 1, the display device 200 also communicates data with a server 400 through various communication methods. The display device 200 may be allowed to communicate and connect through a Local Area Network (LAN), a Wireless Local Area Network (WLAN), and other networks.

In addition to providing broadcast reception television functions, the display device 200 may also additionally provide smart network television functions with computer support functions, which may include but are not limited to, Internet TV, smart TV, Internet Protocol Television (IPTV), etc.

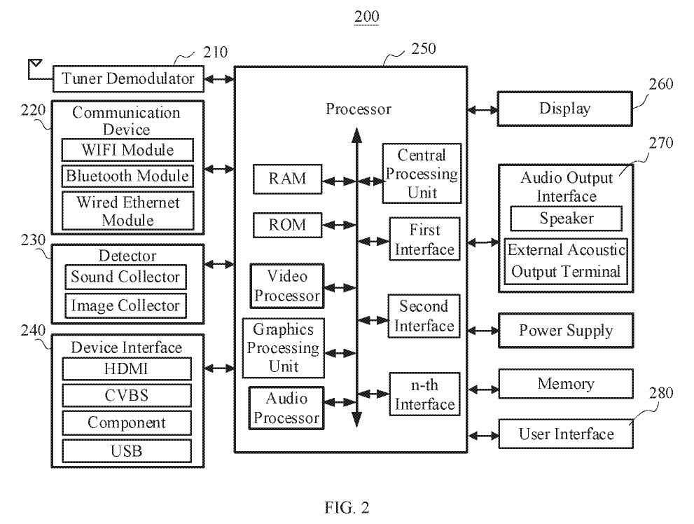

FIG. 2 is a hardware configuration block diagram of a display device according to some embodiments of the present disclosure. In some embodiments, the display device 200 may include at least one of a tuner demodulator 210, a communication device 220, a detector 230, a device interface 240, at least one processor 250, a display 260, an audio output interface 270, a memory, a power supply, or a user interface.

In some embodiments, the detector 230 may be used to collect signals from the external environment or for external interaction. For example, the detector 230 may include a light receiver, and a sensor for collecting ambient light intensity; or, the detector 230 may include an image collector, such as a camera, for collecting external environmental scenes, user attributes or user interaction gestures; or, the detector 230 may include a sound collector, such as a microphone, for receiving external sounds.

In some embodiments, the display 260 may include a display screen assembly for presenting a picture, and a driving assembly for driving image display, and may be used for receiving image signals output from the at least one processor, and for displaying video content, image content, a menu control interface, and a user interface (UI) for user control.

In some embodiments, the communication device 220 is a component that can be used to communicate with an external device or the server 400 according to various communication protocol types.

In some embodiments, the at least one processor 250 may include a central processing unit (CPU), a video processor, an audio processor, a graphics processor, a random access memory (RAM), a read-only memory (ROM), a first interface to an n-th interface for input/output. The at least one processor 250 can control the operation of the display device and respond to user operations through various software control programs stored in the memory. The at least one processor 250 can control the overall operation of the display device 200.

In some embodiments, the at least one processor 250 and the tuner demodulator 210 may be located in different separate devices, i.e., the tuner demodulator 210 may also be in an external device, such as an external set-top box, of the main device where the at least one processor 250 is located.

In some embodiments, the user can input user commands on a graphical user interface (GUI) displayed on the display 260, and the user input interface receives the user input commands through the GUI.

In some embodiments, the user interface 280 is an interface that can be used to receive control inputs.

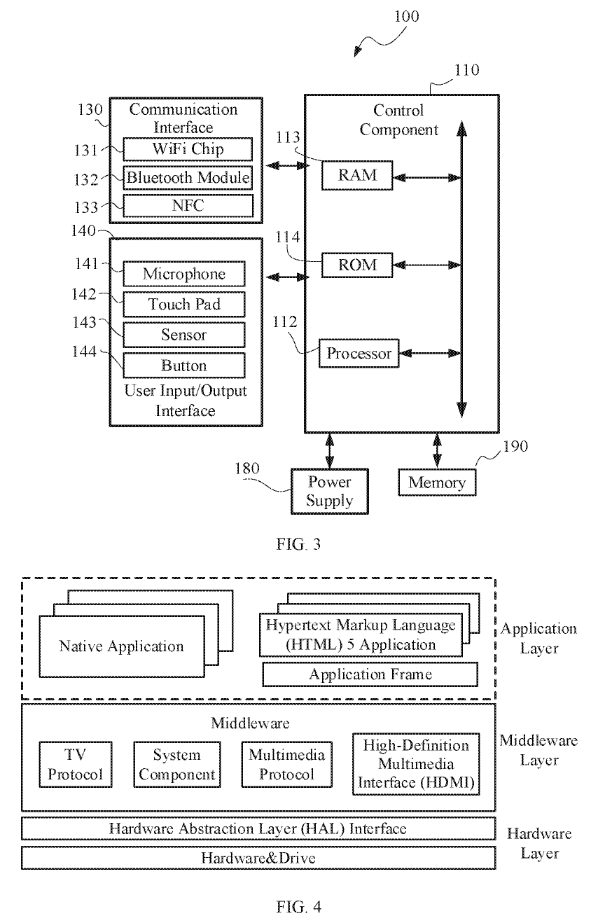

FIG. 3 is a hardware configuration block diagram of a control apparatus according to some embodiments of the present disclosure. As shown in FIG. 3, the control apparatus 100 may include a control component 110, a communication interface 130, a user input/output interface, a memory, and a power supply.

The control apparatus 100 may be configured to control the display device 200, and to receive user input operation instructions, and can convert the operation instructions into instructions recognizable and responsive by the display device 200, serving as an interactive intermediary between the user and the display device 200.

In some embodiments, the control apparatus 100 may be a smart device. For example, the control apparatus 100 can install various applications for controlling the display device 200 according to user needs.

In some embodiments, as shown in FIG. 1, the mobile terminal 300 or other smart electronic device, after installing an application for controlling the display device 200, can perform functions similar to the control apparatus 100.

The control component 110 may include a processor 112, a RAM 113, a ROM 114, a communication interface 130, and a communication bus. The control component 110 may be used to control the operation and functioning of the control apparatus 100, as well as the communication and cooperation between internal components and external and internal data processing functions.

The communication interface 130, under the control of the control component 110, enables communication of control signals and data signals with the display device 200. The communication interface 130 may include at least one of a WiFi chip 131, a Bluetooth module 132, an NFC module 133, or other near-field communication modules.

The user input/output interface 140 includes at least one of an input interface, which may include a microphone 141, a touchpad 142, a sensor 143, a button 144, or other input interfaces.

In some embodiments, the control apparatus 100 may include at least one of the communication interface 130 or the input/output interface 140. The control apparatus 100 may be configured with the communication interface 130, such as WiFi, Bluetooth, NFC modules, etc., and can encode user input instructions via WiFi protocol, Bluetooth protocol, or NFC protocol and send them to the display device 200.

The memory 190 can be used to store various operating programs, data, and applications for driving and controlling the control apparatus 100 under the control of the control component. The memory 190 can store various control signal instructions input by the user.

The power supply 180 can be used to provide operating power support for each element of the control apparatus 100 under the control of the control component.

FIG. 4 is a schematic diagram of a software configuration in a display device according to some embodiments of the present disclosure. In some embodiments, the system of the display device 200 can be divided into three layers, which from top to bottom are an application layer, a middleware layer, and a hardware layer.

The application layer (also referred to as an application program layer) may mainly include common applications on the TV, and an application framework (hereinafter referred to as a “framework layer”), wherein the common applications are mainly applications developed based on a browser Browser, for example: HyperText Markup Language (HTML) 5 APPs; and native applications (Native APPs).

The Application Framework is a complete program model, having all the basic functions required for standard application software, such as: file access, data exchange, etc., and the usage interfaces for these functions (toolbars, status bars, menus, dialog boxes).

Native APPs can support online or offline, message push or local resource access.

The middleware layer may include middleware such as various TV protocols, multimedia protocols, and system components. The middleware can use the basic services (functions) provided by the system software to connect various parts of the application system on the network or different applications, achieving resource sharing and function sharing.

The hardware layer may mainly include a hardware abstraction layer (HAL) interface, hardware, and drivers. The HAL interface can be a unified interface for all TV chips, with the specific logic implemented by each chip. The drivers may mainly include: audio driver, display driver, Bluetooth driver, camera driver, WIFI driver, USB driver, High-Definition Multimedia Interface (HDMI) driver, sensor driver (such as fingerprint sensor, temperature sensor, pressure sensor, etc.), and power driver, etc.

In some embodiments, the application program layer of the display device 200 may include at least one application. For example, an icon control interface of applications in the display device 200 may include a live TV application icon control, a video-on-demand application icon control, a media center application icon control, an application center icon control, a game application icon control, and the like.

In some embodiments, the live TV application can provide live TV and broadcast television through different signal sources. For example, the live TV application can use inputs from cable TV, radio broadcasts, satellite services, or other types of live TV services to provide TV signals. Furthermore, the live TV application can display media data of live TV signals on the display device 200.

In some embodiments, the video-on-demand application can provide videos from different storage sources. Unlike live TV applications, video-on-demand provides media data from certain storage sources. For example, video-on-demand can be from a server-side cloud storage or from a local hard disk storage containing pre-stored video programs.

In some embodiments, the application center can store various applications. An application can be a game, an application, or other applications related to a computer system or other devices that can run in a smart TV. The application center can obtain these applications from different sources, store them in a local storage, and then run them on the display device 200.

In some embodiments, the display device 200 can also connect to other external devices through the device interface 240, i.e., the device interface 240 can be configured to connect to an external device. The external device interface can be a USB interface, an HDMI interface, etc. For example, the display device 200 can connect to an external device such as a game console through an HDMI interface, and display a playback picture corresponding to the external device through the display 260.

The above embodiments introduce the hardware/software architecture and function implementation of the display device 200. In some application scenarios, to improve the display effect of the display device 200, the display device 200 can adjust image parameters of the playback picture, such as image quality, brightness, color, sharpness, contrast, or color temperature, through an image setting function. The image setting function is implemented based on an image settings page. The user can call up the image settings page based on a settings page of the display device 200, and then adjust each image parameter through each menu item on the image settings page.

In the display device 200, the overall One-panel page of the settings page can be a Fragment. A Fragment is a part of an Activity, can appear as a part of an Activity, and can also be used in multiple Activities. The Fragment of the settings page can include multiple menu items, i.e., the menu items can be declared in the layout file of the Fragment. The layout file can include control elements, layout attributes, and various resource reference information in the fragment.

Similarly, the overall page of the image settings page can also be a Fragment, and this Fragment can also include multiple menu items. For ease of user operation, each menu item can include multiple adjustable sub-options, each sub-option corresponds to a different option value, i.e., each option value represents a different option. For example, the Local Dimming menu item on the image settings page may correspond to five selectable option contents: “High”, “Medium”, “Low”, “On”, “Off”, and these option contents correspond to five different option values respectively.

In some embodiments, the settings page and the image settings page may use one -panel, and the image settings page serves as a menu item in the settings page. That is, when the user performs a selection operation on the image settings menu item, the display device 200 can refresh the settings page to present relevant content of the image settings page.

In some embodiments, menu item parameters of each menu item on the image settings page are stored in a layout file of the image settings page. The menu item parameters may include but are not limited to the option value, the enabled attribute, the title parameter, the background color, etc., of the menu item. The option values of the menu items are stored through a controllable list, the controllable list is used to record the option values of the menu item. When displaying the menu item, the image settings page switches each sub-option of the menu item in accordance with the position order of the current option value in the controllable list.

To facilitate adjusting the image parameters of the display device 200, in some embodiments, the display device 200 can automatically switch between different picture modes when playing media data of different sources or accessing different external devices. Different picture modes are associated with different image parameters, i.e., different picture modes are set with different image parameters. For example, when the display device 200 is connected to a sound system through an HDMI interface, the user sets the picture mode to standard mode. Then, the user unplugs the sound system and connects a game console. The display device 200 automatically generates a plug-unplug signal of the HDMI interface, responds to the plug-unplug signal of the HDMI interface, detects the device type connected to the HDMI interface, and automatically switches the picture mode to game mode according to the device type of the game console.

Therefore, in some embodiments, the display device 200 configures corresponding picture modes for sources of different signal sources and different types of sources. For example, Dolby-type sources provided by different signal sources may correspond to Dolby Vision IQ mode, Dolby Vision Dark mode, Dolby Vision Custom mode, etc.; High-Dynamic-Range (HDR)-type sources provided by different signal sources may correspond to HDR Vivid mode, HDR Standard mode, HDR Theater mode, etc.; Standard Dynamic Range (SDR)-type sources provided by network application signal sources and HDMI signal sources may correspond to Vivid mode, Standard mode, Energy Saving mode, Sports mode, Daytime Cinema mode, Nighttime Cinema mode, etc.

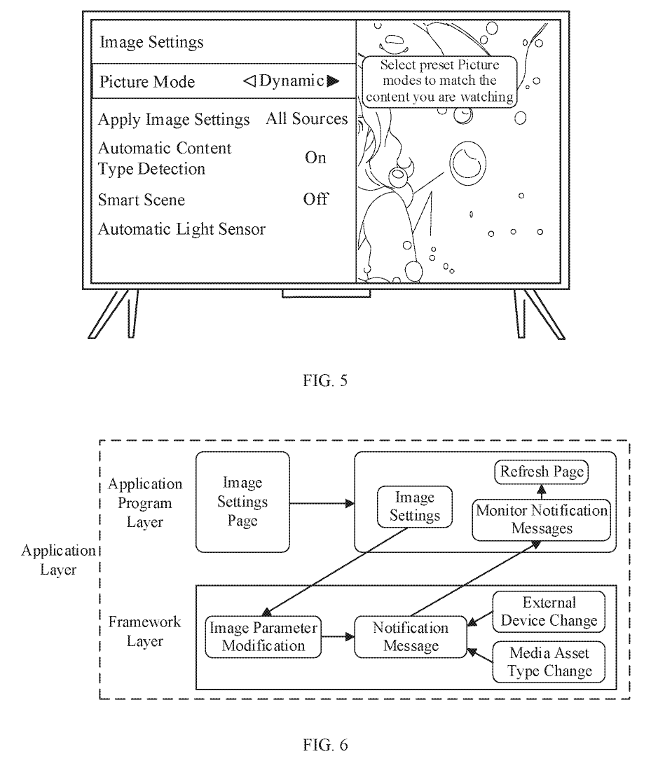

In some embodiments, when playing media data or displaying a playback picture of an external device, the display device 200 can simultaneously display an image settings page in a top layer on the playback picture, and modify image parameters of the display device 200 through the image settings page, i.e., the display priority of the image settings page is higher than the display priority of the playback picture. The image settings page may include a Picture Mode Settings menu. The Picture Mode Settings menu is a comprehensive setting item in the image setting function. The picture mode of the display device 200 can be switched through the Picture Mode Settings menu, and multiple image parameters can be modified simultaneously. For example, as shown in FIG. 5, FIG. 5 is a display effect diagram of an image settings page according to some embodiments of the present disclosure. The user can select the image settings menu item on the settings page to call up the Picture Mode Settings menu shown in FIG. 5, so as to modify the image parameters of the display device 200 through the menu items on the image settings page.

The user can switch the current option value of a menu item on the image settings page to set different image parameters. The current option value is the current value of the menu item on the image settings page. Therefore, in some embodiments, the display device 200 monitors the current option value of the menu item. When the user switches the option value of the menu item, the current option value changes. In this way, as shown in FIG. 6, the application program layer of the display device 200 sends a corresponding notification to the framework layer (Application Framework) in accordance with the current value. The framework layer calls the underlying interface in accordance with the notification to modify the image parameters of the display device 200. Since the associated menu items on the image settings page also change after the image parameters or picture mode change, the framework layer also monitors the image parameters. When it detects that the modification of the image parameters is completed, it refreshes the image settings page in accordance with the modified image parameters. That is, the display device 200 re-acquires the layout file of the image settings page in accordance with the modified image parameters.

However, the above-mentioned image settings page may obscure the playback picture of the display device 200, making it impossible for the user to observe real-time changes in the picture while adjusting the image parameters. If the user wants to observe the change in the display effect of the playback picture while adjusting the image parameters, they need to repeatedly switch between the image settings page and the playback picture, which consumes a long operation time, thereby reducing the processing efficiency of image settings and deteriorating user experience.

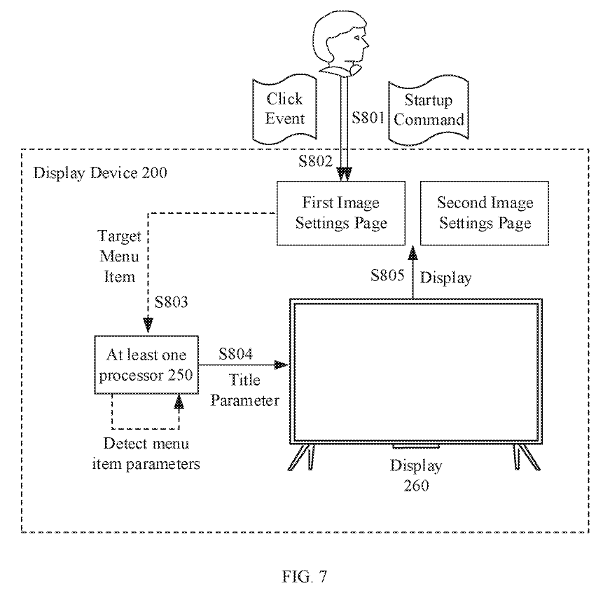

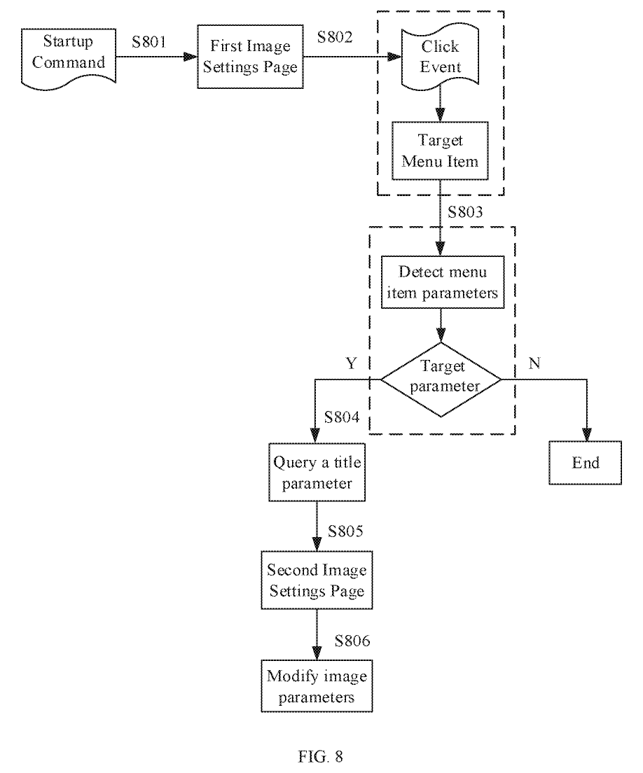

Based on the above application scenario, some embodiments of the present disclosure provide a display device 200. As shown in FIG. 7, the display device 200 may include a display 260, a memory, and at least one processor 250. The display 260 may be configured to display a playback picture, a first image settings page, and a second image settings page. The second image settings page may be used to display a menu item whose menu item parameters on the first image settings page are set with a target parameter. The display priority of the first image settings page and the display priority of the second image settings page may be higher than the display priority of the playback picture. The first image settings page is the image settings page described in the above embodiments, and the second image settings page is a new page derived based on the first image settings page. The memory may be configured to store computer instructions and data associated with the display device 200. As shown in FIG. 8, the at least one processor 250 may be configured to execute the computer instructions to cause the display device 200 to perform the following program steps to improve the image setting processing efficiency in the display device 200.

S801: in response to a startup command sent by a user for displaying a first image settings page, the display is controlled to display the first image settings page.

The first image settings page may include menu items, and the display priority of the first image settings page may be higher than the display priority of the playback picture. After receiving the startup command sent by the user for displaying the first image settings page, the display device 200 can control the display 260 to display the first image settings page in a top layer on the playback picture. The first settings page may include display contents of multiple menu items. In some embodiments, the startup command may be input by the user based on a remote control or other control apparatus 100, or may be input by the user based on a voice command, or may be input by the user based on a touch operation.

In some embodiments, when displaying the first image settings page, the display device 200 may also obtain a layout file of the first image settings page, and display the first image settings page in accordance with the layout file of the first image settings page. The layout file may be an XML file, which can be used to define the layout of each menu item on the first image settings page. For example, the layout file may include Linear Layout, Relative Layout, Absolute Layout, etc., to arrange the display positions of the menu items, and may use controls such as buttons, text boxes, images, etc., to add menu items.

S802: click events for the first image settings page are monitored.

After displaying the first image settings page, the display device 200 can monitor click events generated for the first image settings page. For example, when the user selects a menu item on the first image settings page, the display device 200 can generate a click event corresponding to that menu item. When a click event of a menu item is detected, the display device 200 can detect the menu item parameters of the menu item. The menu item parameters can be item parameters of each menu item stored in the layout file, and may include different layout manners provided in the above embodiments, the current option value of the menu item, etc., and may also include newly added identification parameters to represent different interaction logics, such as page jumping, page closing, etc.

S803: in response to a click event generated by a target menu item on the first image settings page, menu item parameters of the target menu item are detected.

The display device 200 monitors click events of the menu items on the first image settings page. When a click event of the target menu item is detected, it can, in response to the click event, detect the menu item parameters of the target menu item to determine the interaction logic of the menu item.

To facilitate the user to adjust the image parameters of the display device 200, in some embodiments, the menu item parameters of some menu items on the first image settings page may be set with a target parameter. The target parameter may be an identification parameter of the second image settings page. The identification parameter can be used to indicate that the current menu item supports jumping to the second image settings page, i.e., represents the logic of jumping to the second image settings page. The second image settings page may include the display content of the menu item set with the target parameter. The number of menu items included in the second image settings page may be the same as the number of menu items on the first image settings page that can be set with the target parameter. Therefore, the second image settings page may also be referred to as a shortcut menu of the first image settings page. For example, the target parameter may be “Quick Menu”. When the display device 200 detects “Quick Menu” in the item parameters of a menu item, it can obtain the layout file of the second image settings page, and can jump to display the second image settings page in accordance with the layout file of the second image settings page.

To improve the display effect of the display device 200, the enabled attribute of menu items on the first image settings page may change under different picture modes. In some embodiments, when displaying the first image settings page, the display device 200 can detect the enabled attribute of the menu items. If the menu item is in an enabled state, the color value of the menu item may be set to a first value; if the menu item is in a disabled state, the color value of the menu item may be set to a second value. The first value is not equal to the second value, and the colors presented by different color values are also different.

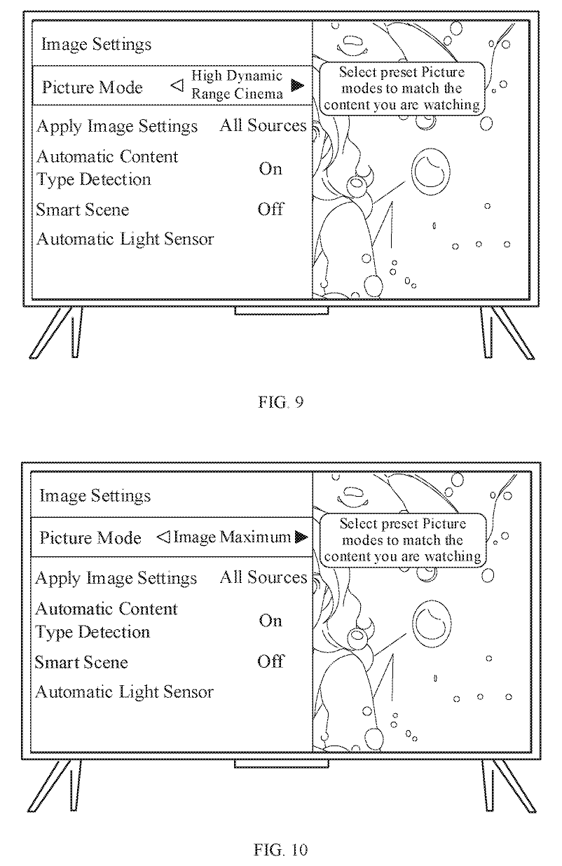

For example, as shown in FIG. 9 and FIG. 10, in HDR Cinema mode, the Smart Scene menu item is modifiable, while in Image Maximum (IMAX) mode, the Smart Scene menu item is not modifiable, and the color values of the Smart Scene menu item are different in the two modes.

Obviously, when the menu item is in a disabled state, the display device 200 cannot respond to a click event for the menu item. Therefore, as shown in FIG. 11, in some embodiments, the display device 200 may also be configured to detect the enabled attribute of the target menu item (S1101). If the target menu item is in a disabled state, the display 260 is controlled to display disabled prompt information (S1102), and the click event is released (S1103). If the target menu item is in an enabled state, whether the target parameter is included is determined (S1104). If the target menu item is in an enabled state and the menu item parameters do not include the target parameter, the display device 200 can detect the current option value of the target menu item based on the first image settings page, and modify the image parameters in accordance with the current option value (S1105).

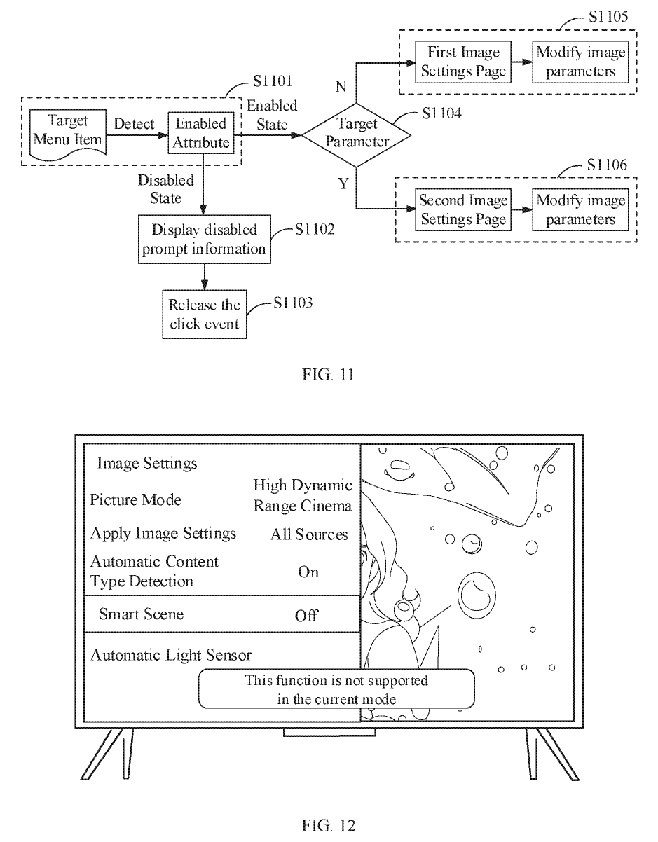

That is, when the target menu item is in a disabled state, the click event can be ignored, and the display 260 displays prompt information indicating that the target menu item is disabled. The prompt information can be may be prompt information displayed via a Toast mechanism to indicate that the target menu item is disabled. For example, as shown in FIG. 12, the display device 200 can display prompt information “This function is not supported in the current mode” at the bottom of the image settings page.

When the target menu item is in an enabled state, the menu item parameters of the target menu item are read. If the menu item parameters do not include the target parameter, it indicates that the target menu item does not support jumping to the second image settings page, and then the image parameters of the display device 200 can be modified in accordance with the current option value of the target menu item on the first image settings page (S1106).

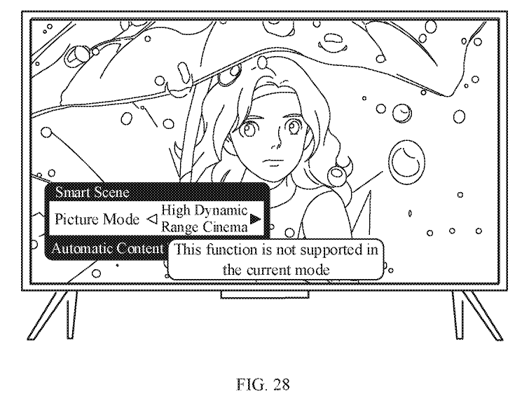

Similarly, in some embodiments, when the display device 200 displays the second image settings page, if the user performs a click event for the target menu item of the second image settings page, the display device 200, in response to the click event input on the target menu item on the second image settings page, can read the enabled attribute of the target menu item on the second image settings page. If the target menu item on the second image settings page is in an enabled state, the image parameters can be modified according to the current option value of the target menu item; if the target menu item on the second image settings page is in a disabled state, the click event can be released, and the display 260 is controlled to display disabled prompt information as shown in FIG. 28.

S804: when the menu item parameters include the target parameter, a title parameter of the target menu item is queried.

The display device 200 can detect the menu item parameters of the target menu item. When it reads that the menu item parameters of the target menu item include the target parameter, it needs to jump to the second image settings page. The target parameter may be an identification parameter of the second image settings page. The second image settings page may include the display content of the target menu item, and the display priority of the second image settings page may be higher than the display priority of the playback picture. To determine the display content of the second image settings page, the display device 200 can read the title parameter of the target menu item, and can pass the title parameter to the second image settings page to determine the display content of the second image settings page through the title parameter of the target menu item.

In some embodiments, the display device 200 may also configure the layout file of the second image settings page. In the layout file, the second image settings page may be set to have a transparent background. Then, a menu item display region is generated based on preset coordinate information. The menu item display region may be used to display the target menu item, and a background of the menu item display region may be a non-transparent background. The menu display region can be set at the bottom left corner, bottom right corner, top left corner, top right corner, etc., of the second image settings page.

In some embodiments, the coordinate information of the menu item display region may include but is not limited to boundary coordinates and center coordinates of the menu display region; the menu display region may have a specific shape attribute. When the menu display region is a rectangle, the coordinate information may also include vertex coordinates.

Since the display priority of the second image settings page is higher than the display priority of the playback picture, the second image settings page can be set to have a transparent background, and the user can directly observe the playback picture located below the second image settings page through the transparent background of the second image settings page, thereby perceiving the change in the quality of the playback picture. Setting the menu item display region displaying the target menu item to have a non-transparent background allows the user to observe in real-time through the menu item display region that the current operation is the modification of image parameters, thereby improving the user’s interactive experience.

In some embodiments, the menu item display region may include the target menu item and a preset number of non-target menu items. The non-target menu items are other menu items on the second image settings page except the target menu item. Moreover, the display region of the target menu item is larger than the display region of the non-target menu items. Since the target menu item is the menu item selected by the user on the first image settings page, when displaying the second image settings page, the display device 200 preferentially displays the content of the target menu item.

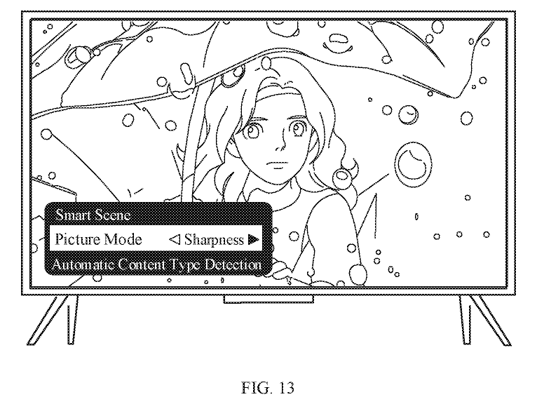

For example, as shown in FIG. 13, FIG. 13 is a schematic diagram of an effect of a second image settings page according to some embodiments of the present disclosure. In the second image settings page, the menu item display region may be set to have a semi-transparent black background, a completely opaque target menu item is displayed above the black background, and two non-target menu items are respectively set above and below the target menu item. The user can use the left and right keys of the remote control apparatus associated with the display device 200 to switch the current option value of the target menu item, and use the up and down keys to select other menu items for operation.

In some embodiments, the menu item display region can be updated according to the background color of the playback picture. That is, to ensure that the menu item display region can be clearly displayed on the playback picture, the display device 200 can detect the background color of the playback picture in real-time, and can adjust the background color of the menu item display region according to the background color of the playback picture, which may include but is not limited to the transparency, color, etc., of the menu item display region.

S805: the display is controlled to display the second image settings page in accordance with the title parameter.

The display device 200 can pass the title parameter to the second image settings page, and can control the display 260 to display the second image settings page according to the title parameter of the target menu item. The second image settings page may include the display content of the target menu item. Since the second image settings page may include multiple menu items, it is necessary to locate the target menu item through its title parameter.

Therefore, in some embodiments, when the display device 200 controls the display 260 to display the second image settings page according to the title parameter, it can obtain the layout file of the second image settings page, and can query the target position of the title parameter in the layout file. Then, according to the target position, the menu items on the second image settings page are switched so that the second image settings page displays the target menu item.

Since each menu item may also have multiple sub-option values, when a menu item has multiple option values, the user can also switch the option values of the menu item to adjust different image parameters. For ease of user operation, in some embodiments, the display device 200 may also detect the number of option values of the target menu item. If the number of option values is greater than or equal to 2, a prompt control of the target menu item may be generated, and the prompt control may be placed in the menu item display region. The prompt control may be used to indicate the controllable range of the menu item. For example, as shown in FIG. 13, left arrow and right arrow prompt controls may be set on the left and right sides of the target menu item to prompt the user that the current target menu item can also switch option values.

Furthermore, to improve the prompt effect of the prompt control, in some embodiments, the display device 200 may also obtain a controllable list for the target menu item. The controllable list may be used to record the option values of the target menu item. Then, based on the second image settings page, the current option value of the target menu item can be detected. If the current option value is at a first position or a last position in the controllable list, the color value of the prompt control may be set to a first value; if the current option value is not at the first position and the last position in the controllable list, the color value of the prompt control may be set to a second value. The second value is not equal to the first value, and the first value and the second value can be color values of various colors, such as red, gray, blue, etc.

Taking the left arrow and right arrow prompt controls as an example, each menu item is provided with a corresponding controllable list, which can indicate the control range of the menu item. The display device 200 can judge the current option value of the target menu item. If the current option value is at the first position in the controllable list, the left arrow may be grayed out; conversely, if the current value is at the last position in the controllable list, the right arrow may be grayed out, thereby prompting the user that the setting critical point of the target menu item has been reached.

When the display device 200 displays the second image settings page, the position of the menu item display region may be displayed according to preset coordinate information, such as the bottom left corner. However, when the playback picture of the display device 200 is different, different content may be displayed in the bottom left corner. Thus, the menu item display region may obscure important information, reducing user experience.

To improve the problem of the menu item display region obscuring important information, in some embodiments, after displaying the second image settings page, the display device 200 may also receive an editing command for moving the target menu item, and in response to the editing command, parse an editing key value of the editing command; and then, modify the coordinate information of the menu item display region according to the editing key value to move the position of the menu item display region.

For example, editing commands input from the remote control are monitored on the second image settings page. When a long-press event of a direction key is detected, the long-press event is encapsulated into a corresponding editing command according to the corresponding key value. The display device 200 can parse the key value in the above editing command to execute the corresponding editing operation. The direction keys include Up, Down, Left, and Right. The display device 200 can respond to a long-press event of Up to move the menu item display region upward on the second settings page; respond to a long-press event of Down to move the menu item display region downward on the second settings page; respond to a long-press event of Left to move the menu item display region leftward on the second settings page; respond to a long-press event of Right to move the menu item display region rightward on the second settings page. In this way, the user can customize the menu item display region and adjust it to any position.

It is understandable that the above-mentioned movements of the menu item display region all convert the coordinates of the menu item display region to change the display region of the menu item. The display device 200 can monitor the long-press event. When the user releases the key of the remote control, the display device 200 stops moving the menu item display region. In some examples, the long-press event may also be a double-click event, etc. Alternatively, in other examples, the user may also trigger an editing mode through a specific key. After the display device 200 enters the editing mode, the menu item display region can be moved through short-press events or long-press events. In this case, the long-press event is real-time sliding, and a fixed step size is set in the display device 200. In response to the short-press event, the menu item display region is moved according to the step size, thereby reducing conflicts with other key operations. For example, the step size is 10 pixels, and each time a short-press event is responded to, each coordinate of the menu item display region is moved by 10 pixels.

S806: image parameters are modified based on the target menu item on the second image settings page.

After displaying the second image settings page, the display device 200 can modify the image parameters of the display device 200 through the target menu item on the second settings page, thereby presenting different display effects. The background of the second image settings page is a transparent background, and only the content of the target menu item is displayed in the menu item display region, so the obscuring of the playback picture by the image settings page can be reduced, allowing the user to observe the effect of changes in image parameters in real-time. Moreover, the user can also customize the position of the menu item display region on the second image settings page, which can improve the problem of the menu item display region obscuring important information.

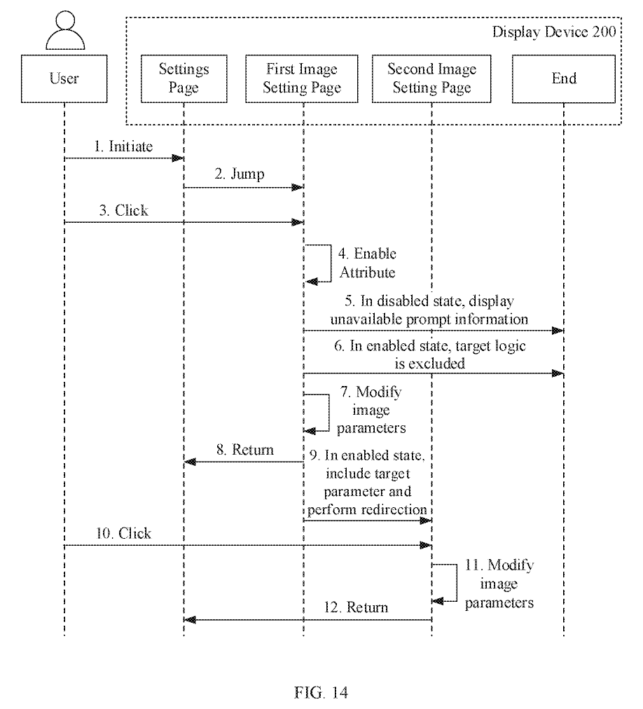

Based on the above embodiment, for example, as shown in FIG. 14, FIG. 14 is a timing diagram of interaction between a first image settings page and a second image settings page according to some embodiments of the present disclosure. The user can start the settings page of the display device 200 (1), so as to jump to the first image settings page through the settings page (2), and perform a click operation on the target menu item on the first image settings page (3). The enabled attribute of the target menu item is detected (4). If the target menu item is in a disabled state, prompt information indicating that the target menu item is unavailable is displayed (5); if the target menu item is in an enabled state, the menu item parameters of the target menu item are determined. If the target menu item supports jumping to the second image settings page, i.e., the menu item parameters include the target parameter, the second image settings page is jumped to and displayed (9). If the user performs a click operation on the second image settings page (10), the image parameters are modified based on the second image settings page (11); if the target menu item does not support jumping to the second image settings page, the image parameters are modified based on the first image settings page (7). On the first image settings page and the second image settings page, the settings page of the display device 200 can be returned through a return operation from the user (8 or 12). After determining that the target menu item is in an enabled state, it further determines whether the target logic (6), i.e., the processing logic according to the present application, is included. If not, the process ends; if so, it further determines the menu item parameters of the target menu item to determine whether to support jumping to the second image settings page, and based on the support situation, uses the above processing flow to execute the corresponding operation.

From the above solution, the display device 200 according to some embodiments of the present disclosure can, in response to a startup command for displaying a first image settings page, display the first image settings page, and detect operation events for the first image settings page. Then, in response to a click event input on a target menu item on the first image settings page, it detects menu item parameters of the target menu item. When the menu item parameters include an identification parameter of a second image settings page, it queries a title parameter of the target menu item, and controls the display to display the second image settings page. Then, it modifies image parameters based on the target menu item on the second image settings page. The method adds an identification parameter of the second image settings page to the menu item parameters of the menu item, allowing the user to call up a shortcut settings page including that menu item based on a specific menu item, and set image parameters through the shortcut settings page, thereby improving the processing efficiency of image settings.

To ensure a good display effect, in some embodiments, after the image parameters of the display device 200 change, the content of the corresponding first image settings page or second image settings page will also change. That is, after detecting the change in image parameters, the display device 200 re-acquires the layout file of the first image settings page or the second image settings page, and refreshes the first image settings page or the second image settings page according to the re-acquired layout file.

For example, as shown in FIG. 9 and FIG. 10, taking the menu item of picture mode as an example, in HDR Cinema mode, the Smart Scene menu item is modifiable, while in Image Maximum (IMAX) mode, the Smart Scene menu item is not modifiable. When the display device 200 switches from HDR Cinema mode to IMAX mode, the display device 200 re-acquires the layout file, and the new layout file at least includes the disabled attribute of the Smart Scene menu item.

It is understandable that the above embodiment is only described using the enabled attribute of the menu item. When the image parameters of the display device 200 change, in the layout files of the first image settings page and the second image settings page the types and numbers of associated menu items, as well as the parameter values and attributes of various menu item parameters such as the current option value and controllable range of the menu items may also be updated.

Therefore, in some embodiments, when the display device 200 modifies the image parameters based on the second image settings page, it detects the current option value of the target menu item based on the second image settings page. The image parameters are modified according to the current option value, and a first updated layout file is obtained. The first updated layout file is a layout file of a menu item associated with the second image settings page after the image parameters have been modified. That is, after detecting that the user has modified the image parameters based on the second image settings page, the display device 200 re-acquires the layout file of the second image settings page. Then, the second image settings page is refreshed according to the first updated layout file, so that the second image settings page presents menu items related to the current image parameters.

Similarly, when the picture mode of the display device 200 changes, the content of the menu items associated with the picture mode may also change. In this case, the display device 200 needs to refresh the content of the second image settings page. The change of the picture mode may be actively switched by the user, or may be automatically triggered by a change in the external device connected to the display device 200.

Therefore, in some embodiments, mode change events of the display device 200 are monitored. The mode change events may include a change event of a picture mode. When a mode change event is detected, a second updated layout file may be obtained. The second updated layout file may be a layout file of a menu item associated with the second image settings page after the mode change event has been executed. Thus, after detecting a change in the picture mode, the display device 200 can re-acquire the layout file of the second image settings page. Then, the second image settings page is refreshed according to the second updated layout file.

Similarly, in some embodiments, the picture mode of the display device 200 may also change according to the media type of the display device 200. That is, when the media source being played by the display device 200 changes, the display device 200 also switches the picture mode and re-acquires the layout file to refresh the second image settings page.

It should be noted that the principle of refreshing the first image settings page is the same as that of refreshing the second image settings page. The refreshing process of the first image settings page can refer to the refreshing process of the second image settings page described above, and will not be repeated here.

Still as shown in FIG. 6, the user opens the image settings page based on the application program layer of the display device 200, and opens the second image settings page through the first image settings page of the image settings page. Then, the image parameters are modified through the menu items on the second image settings page. The framework layer (Application Framework) of the display device 200 receives a control command for modifying the image parameters and adjusts the image parameters. In this way, after determining that the image parameters have been adjusted, the framework layer associates other image parameters affected by this image parameter modification, and passes them to the application program layer through a notification message. The application program layer monitors the notification message and refreshes the second image settings page.

Alternatively, when the external device or the playback source changes, the framework layer of the display device 200 detects the change, parses the image parameters that need to be refreshed, and passes the parsed result to the application program layer through a message. When the application program layer receives the message, it refreshes the page in real-time.

However, a menu item on the first image settings page or the second image settings page may be associated with multiple image parameters. When modifying the image parameters based on this menu item, the display device 200 needs to wait for a certain response time. Since the display device 200 needs to wait for the image parameter modification to complete before refreshing the image settings page, when the menu item has multiple sub-options, the display device 200 needs to respond to each sub-option of the menu item sequentially, consuming a long response time, thereby reducing the refresh efficiency of the first image settings page or the second image settings page and deteriorating user interaction experience.

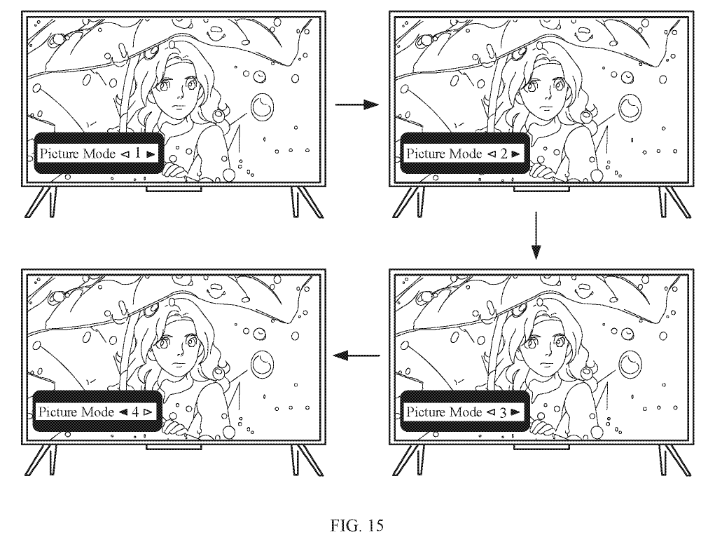

For example, as shown in FIG. 15, when the user switches the picture mode on the image settings page, since there are multiple sub-options for the menu item of picture mode, if the user wants to switch from the first sub-option in the picture mode to the fourth sub-option, they will quickly switch each sub-option of the menu item. The display device 200 also needs to respond to the image parameters of the intermediate items, i.e., the second sub-option and the fourth sub-option, responding to three image parameter modifications in total, causing unnecessary waste of system resources and time.

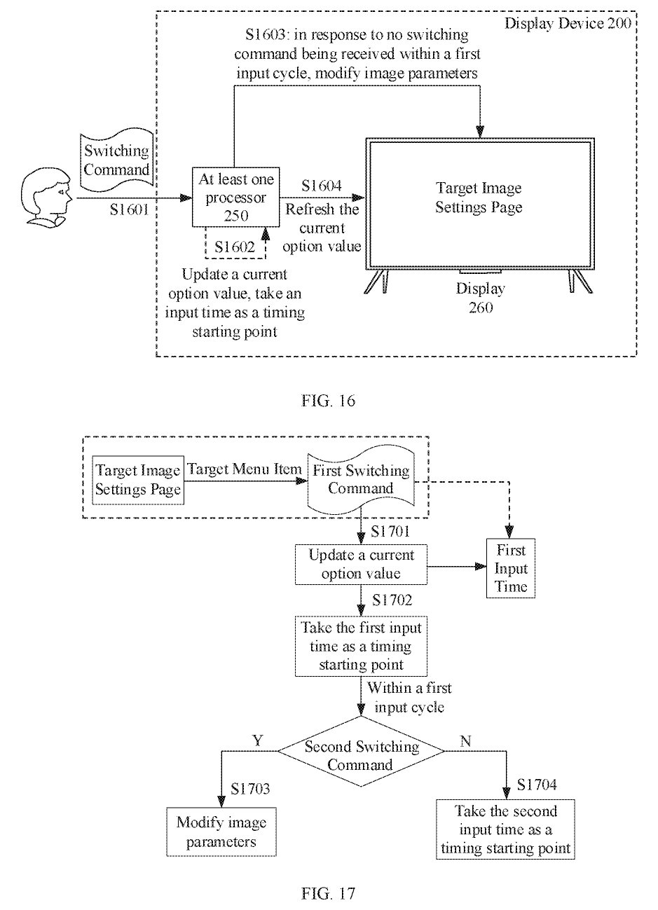

Based on the above application scenario, the display device 200 provided in some embodiments of the present disclosure, as shown in FIG. 16, includes a display 260 further configured to display a target image settings page. The target image settings page may include menu items. The target image settings page may be the first image settings page described in the above embodiments, or may be the second image settings page described in the above embodiments, to improve the refresh efficiency of the first image settings page or the second image settings page. As shown in FIG. 16, the at least one processor 250 of the display device 200 receives a switching command input by the user (S1601), updates the current option value of the target menu item on the target image settings page in response to the switching command, and uses the input time of the switching command as the timing starting point (S1602), monitors whether a switching command is received within a first input cycle; if no switching command is received within the first input cycle, modifies the image parameters based on the current option value on the target image settings page (S1603); if a switching command is received within the first input cycle, refreshes the current option value (S1604).

As shown in FIG. 17, the at least one processor 250 is further configured to execute the computer instructions stored in the memory to cause the display device 200 to perform some or all of the following program steps.

S1701: in response to a first switching command input on a target menu item on the target image settings page, a current option value of the target menu item on the target image settings page is updated, and a first input time of the first switching command is read.

The user can modify image parameters through the menu items on the target settings page. When the user inputs a switching command based on a target menu item on the target image settings page, the display device 200 needs to switch the sub-options of the target menu item, i.e., update the current option value of the target menu item. After the option value of the target menu item is updated, the display content of the target menu item will also switch to the corresponding display content. The switching command may be an operation command for switching the option value of the menu item, or may be input by the user through a specific key of the control apparatus 100, or may be input by the user by touching an operation control on the image settings page. For example, on the image settings page shown in FIG. 5, the currently selected target menu item is the picture mode. The user can input a picture mode switching command using the right key of the remote control.

In some embodiments, this switching command is recorded as a first switching command. When receiving the first switching command, the display device 200 can, in response to the first switching command, read the first input time of the first switching command, to monitor, through the first input time, the time interval for the user to input switching commands based on the target menu item on the target image settings page.

S1702: a switching command is monitored within a first input cycle by taking the first input time as a timing starting point.

After reading the first input time of the first switching command, the display device 200 can start timing with the first input time as the timing starting point, and can continue to receive switching commands within the first input cycle, i.e., monitor the switching commands. The first input cycle may be a preset time cycle, which can be freely set according to the response time of each menu item. For example, the first input cycle may be set to 300 milliseconds.

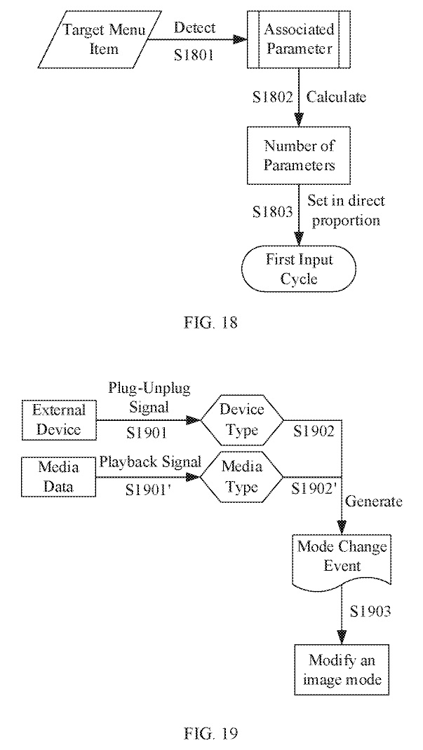

Since the image parameters associated with each menu item are different, the time consumed by the display device 200 when executing the switching command for each menu item is also different. For example, taking two menu items, i.e., the picture mode and the brightness, as examples, modifying the picture mode will cause changes in five associated image parameters, while modifying brightness only involves changes in the brightness parameter and does not cause changes in other associated image parameters. Therefore, the time required for the display device 200 to execute the switching command for the picture mode may be longer than the time for executing the switching command for brightness. Therefore, the display device 200 can also set different first input cycles according to the image parameters associated with the menu item. That is, in some embodiments, as shown in FIG. 18, the display device 200 can also detect associated parameters of the target menu item on the target image settings page (S1801). The associated parameters may be the image parameters associated with the target menu item on the target image settings page. Then, the number of the associated parameters is calculated (S1802), and the first input cycle can be set according to the number of the associated parameters (S1803). The value of the first input cycle is directly proportional to the number of the associated parameters. That is, the more image parameters associated with the target menu item on the target image settings page, the longer the first input cycle set by the display device 200.

For example, when the menu item is the picture mode, the picture mode is associated with 5 parameters, and the display device may set the first input cycle to 300 milliseconds; when the menu item is brightness, brightness is associated with 1 parameter, and the display device may set the first input cycle to 60 milliseconds.

S1703: in response to no second switching command being received within the first input cycle, the image parameters are modified in accordance with the current option value.

The second switching command is a switching command with an input time later than the first input time. The display device 200 starts timing with the first input time as the timing starting point. If no second switching command is received within the first input cycle, i.e., no further switching command for the target menu item on the target image settings page is received within the first input cycle, it indicates that the first switching command may be the image parameter the user wants to adjust. The display device 200 can then call the underlying interface settings to modify the image parameters according to the current option value of the first switching command.

In some application scenarios, after the display device 200 modifies the image parameters, the display content of the target image settings page may also change, i.e., the modification of the image parameters triggers an automatic refresh of the target image settings page. For example, when the target menu item is the picture mode, after the user switches the picture mode from Dynamic mode to Sports mode, the display device 200 refreshes the image settings page, updating the display content associated with Dynamic mode to the display content associated with Sports mode.

Therefore, in some embodiments, when the display device 200 modifies the image parameters according to the current option value, it may generate a parameter adjustment notification according to the current value, and query a linked menu item based on the parameter adjustment notification. Then, the linked menu item is sent to the application program layer, so that the application program layer updates the target image settings page according to the linked menu item.

Taking the target menu item as the picture mode as an example, after the user modifies the sub-option of the picture mode, the framework layer of the display device 200 determines the linked menu item of the current picture mode, and can notify the application program layer to update through a message. After receiving the message, the application can call the underlying interface settings to modify the image parameters of the display device 200.

Furthermore, when the external device connected to the display device 200 or the media type of the played media changes, the picture mode is automatically refreshed, and the display device 200 also automatically modifies the image parameters and refreshes the target image settings page. That is, in some embodiments, mode change events of the display device 200 are monitored. The mode change events may include a change event of a picture mode, and the picture mode is associated with the image parameters. When a mode change event is detected, a target option value of the mode change event can be parsed, and the menu items on the target image settings page can be refreshed according to the target option value.

As shown in FIG. 19, in some embodiments, in response to a plug-unplug signal generated when an external device is connected or disconnected, the display device 200 can detect a device type of the external device (S1901). Then, the mode change event is generated in accordance with the device type (S1902), and the picture mode is modified in response to the mode change event (S1903).

Similarly, in some embodiments, in response to a playback signal generated when the display device 200 plays media data, the media type of the media data can also be detected (S1901’). Then, the mode change event is generated in accordance with the media type (S1902’), and the picture mode is modified in response to the mode change event (S1903). When playing media data of different media types, the display device 200 generates different playback signals, which may be digital signals or analog signals.

S1704: in response to a second switching command being received within the first input cycle, a second input time of the second switching command is read, and the switching command is received within the first input cycle by taking the second input time as the timing starting point.

The display device 200 starts timing with the first input time as the timing starting point. If a second switching command is received within the first input cycle, i.e., a switching command for the target menu item on the target image settings page is received within the first input cycle again, it indicates that the first switching command is not the image parameter the user wants to adjust. In this case, the display device 200 does not need to call the underlying interface settings to modify the image parameters, but only needs to refresh the current value of the target menu item on the target image settings page. At the same time, the display device 200 restarts timing with the newly received second switching command as the timing starting point to determine the time interval between the next switching command and the second switching command.

Based on the above embodiment, the display device 200 in the embodiment of the present disclosure can, upon receiving a switching command input by the user based on the target menu item on the target image settings page, promptly refresh the current option value of the target menu item on the target image settings page, allowing the user to perceive the response of the target menu item on the image settings page to the switching command, thereby ensuring user interaction experience. When the time interval between two input switching commands is less than or equal to the preset input cycle, the display device 200 does not call the underlying interface settings to modify the image parameters, thereby reducing the time waste caused by the display device 200 responding to intermediate items, and accelerating the refresh efficiency of the image settings page. When the time interval between two input switching commands is greater than the input cycle, the display device 200 can call the underlying interface settings to modify the image parameters, thereby ensuring the normal modification of the image parameters.

However, the modification of the image parameters may trigger the refresh of the target image settings page in the display device 200. For example, when the user actively modifies the image parameters, when the device type of the external device changes, or when the media type of the media data being played changes, the refresh of the target image settings page may be triggered. When refreshing the target image settings page, the display device 200 displays the target image settings page according to a new layout file, which inevitably refreshes the current option value of the target menu item on the target image settings page. In this way, if the user is operating to switch the sub-options of the target menu item on the target image settings page, a sudden data jump may occur, affecting the user’s interaction experience.

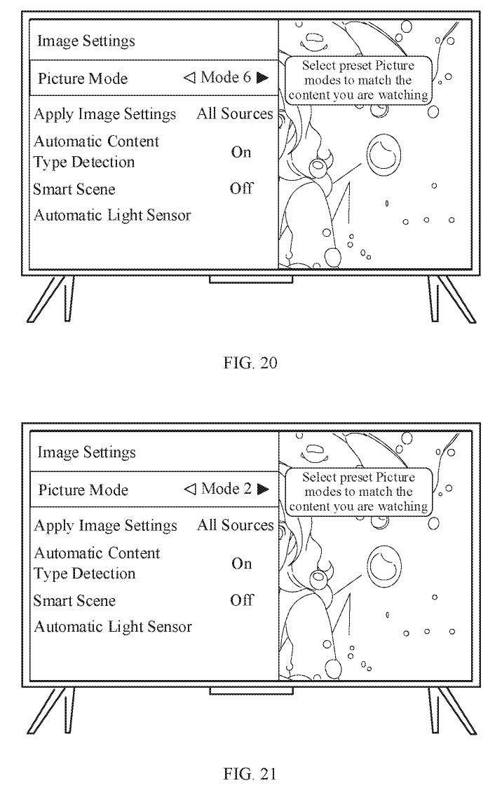

Taking the user actively modifying the image parameters as an example, the sub-options of the picture mode may include mode 1, mode 2, mode 3, mode 4, mode 5, and mode 6. The user clicks continuously on the menu item of the picture mode, inputting switching commands based on the target menu item on the target image settings page to switch the sub-options of the target menu item on the target image settings page. The user wants to switch the image setting sub-option from mode 1 to mode 6; however, when switching to mode 2, due to a pause in the user’s operation, the input time of the switching command exceeds the first input cycle. The display device 200 then calls the underlying interface settings to modify the image parameters of mode 2. After the image parameter modification is complete, the display device 200 automatically refreshes the target image settings page according to the modified image parameters. In this way, as shown in FIG. 20, the user has continued operating to switch the sub-option of the picture mode to 6, but due to the automatic refresh of the target image settings page, the picture mode is automatically refreshed to the sub-option of mode 2, as shown in FIG. 21, causing a data jump problem.

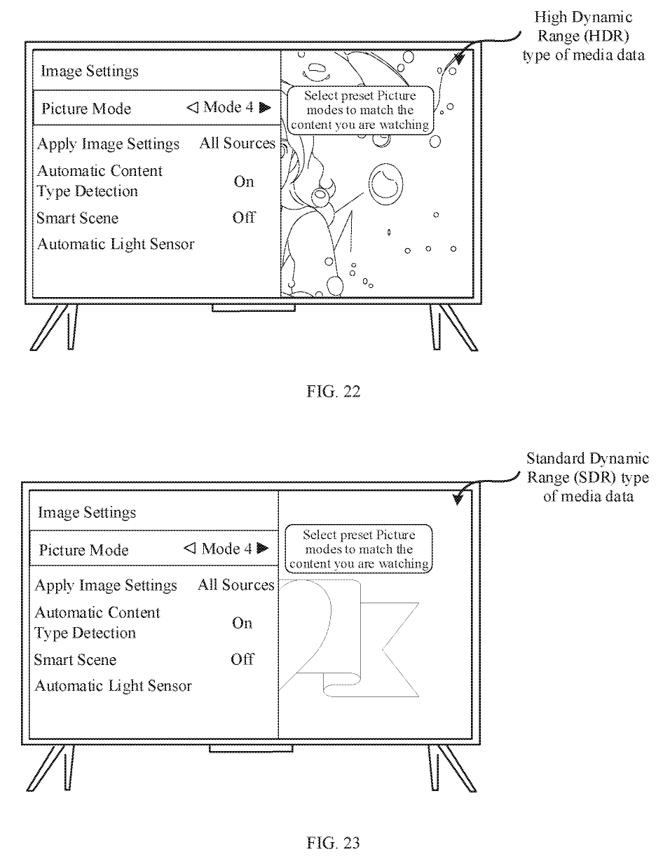

Taking the change of media type as an example, the sub-options of the picture mode may include mode 1, mode 2, mode 3, mode 4, mode 5, and mode 6. The user clicks continuously on the menu item of the picture mode, inputting switching commands based on the target menu item on the target image settings page to switch the sub-options of the target menu item on the target image settings page. The display device 200 is playing media data of a High Dynamic Range (HDR) Imaging type. The user wants to switch the image setting sub-option from mode 1 to mode 6; however, as shown in FIG. 22, when the user switches to mode 4, the HDR type media playback ends, and the display device 200 automatically plays the next media data. The media type of the next media data is a Software Defined Radio (SDR) type. In this way, the display device 200 refreshes a new image settings page according to the SDR type, and the sub-option of the target menu item is switched back to mode 4, as shown in FIG. 23, causing a data jump problem.

In some embodiments, when the display device 200 executes the refresh of the target image settings page, it can read a state flag of the target image settings page. The state flag may be used to indicate an input state of a switching command. If the state flag is a first flag, the current option value of the target menu item on the target image settings page can be locked, and the menu items on the target image settings page are refreshed. The first flag may indicate that the user is currently inputting a switching command, i.e., the user is performing a control operation. If the state flag is a second flag, the current option value of the target menu item on the target image settings page and the menu items on the target image settings page can be refreshed. The second flag may indicate that the user is not currently inputting a switching command, i.e., the user is not currently performing a control operation. In this way, by setting the state flag, the image settings page can be updated in a timely manner, and the jump problem of the current option value in the target menu item on the target image settings page can be improved, thereby improving the user’s interaction experience.

To facilitate setting the state flag, the state flag can be set according to the time interval of the user’s input switching commands. That is, in some embodiments, a switching command for the target image settings page can be monitored, and when the first switching command is detected, the state flag is set to the first flag. Furthermore, in response to no second switching command being received within a second input cycle, the state flag is set to the second flag. The value of the second input cycle is greater than the value of the first input cycle.

For example, as shown in FIG. 24, when the user clicks a key on the remote control to switch the sub-option of the target menu item, the state flag is set to true (S2401). In this way, if a notification of modifying image parameters or a mode change event is detected (S2402), the menu items on the target image settings page are refreshed, but the current option value of the target menu item on the target image settings page is not refreshed, i.e., the current option value of the target menu item on the target image settings page is locked, and other menu items are refreshed (S2403); when the clicking stops for more than the second input cycle, the state flag is set to false (S2404). Thereafter, if a notification of modifying image parameters or a mode change event is received (S2405), the entire target image settings page, which may include the current option value of the target menu item, is refreshed i.e., all menu items of the target image settings page are refreshed (S2406).

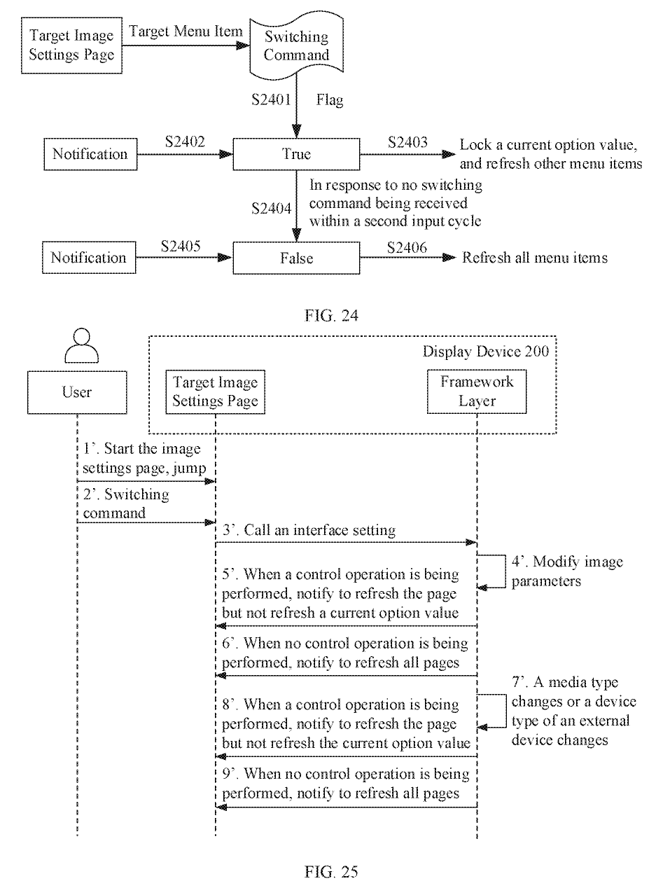

For example, FIG. 25 is a timing diagram of refreshing a target image settings page according to some embodiments of the present disclosure; and FIG. 26 is a schematic diagram of software logic processing for refreshing a target image settings page according to some embodiments of the present disclosure. The user starts the image settings page, and the display device 200 jumps to display the target image settings page (1’). The user switches the picture mode on the target image settings page (2’), notifying the application program layer of the target image settings page to refresh the target image settings page. The application program layer sends a notification to the framework layer to call the underlying interface settings (3’) to modify the image parameters of the target menu item in a linked manner (4’), reads the state flag, and parses the user’s operation state based on the state flag. If the user is performing a control operation, the target image settings page is refreshed, but the current option value of the target menu item on the target image settings page is not refreshed (5’); if the user is not currently performing a control operation, the entire target image settings page is refreshed (6’). The framework layer can also monitor the media type of the media data and the device type of the external device (7’). When the media type or device type changes, if the user is performing a control operation, the target image settings page is refreshed, but the current option value of the target menu item on the target image settings page is not refreshed (8’); if the user is not currently performing a control operation, the entire target image settings page is refreshed (9’).

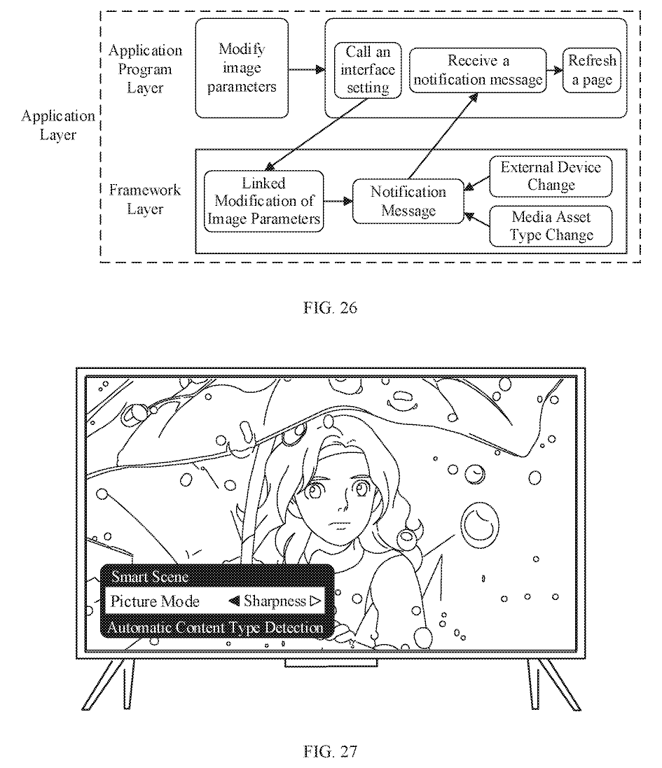

Furthermore, to facilitate the user to input corresponding switching commands on the target image settings page, in some embodiments, the display device 200 may also obtain a controllable list for the target menu item on the target image settings page. The controllable list may be used to record the option values of the target menu item on the target image settings page. Then, the current option value of the target menu item on the target image settings page is detected. If the current option value is at a first position or a last position in the controllable list, the color value of the prompt control may be set to a first value; if the current option value is not at the first position and the last position in the controllable list, the color value of the prompt control may be set to a second value. The prompt control may be used to indicate the controllable range of the menu item, and the second value may not be equal to the first value. For example, the first value may be gray, black, etc., and the second value may be blue, green, etc. For example, as shown in FIG. 13, when the current option value is at the last position in the controllable list, the right arrow may be set to black; as shown in FIG. 27, when the current option value is at the first position in the controllable list, the left arrow may be set to black.

From the above solution, the display device according to some embodiments of the present disclosure can, in response to a first switching command input by the user based on a target menu item on a target image settings page, update the current option value of the target menu item on the target image settings page, and read the first input time of the first switching command. Then, the first input time can be used as the timing starting point to receive a switching command within the first input cycle. If no second switching command is received within the first input cycle, the image parameters can be modified according to the current option value. If a second switching command is received within the first input cycle, the second input time of the second switching command can be read, and the second input time is used as the timing starting point to receive the switching command within the first input cycle. In this way, when the input time between two switching commands is less than a preset input time cycle, the display device can refresh only the current option value but not modify the image parameters, thereby reducing the time consumption caused by intermediate items and improving the refresh efficiency of the image settings page.

Based on the above display device 200, some embodiments of the present disclosure further provide a method for optimizing image settings for a display device. As shown in FIG. 8, the method may include but is not limited to the aforementioned steps S801 to S806, which will not be repeated here.

Based on the above display device 200, some embodiments of the present disclosure further provide another method for optimizing image settings for a display device. As shown in FIG. 17, the method may include but is not limited to the aforementioned steps S1701 to S1704, which will not be repeated here.

The same or similar parts between the various embodiments in this specification can refer to each other, and will not be repeated here.

Those skilled in the art can clearly understand that the technology in the embodiments of the present disclosure can be implemented by means of software plus a necessary general hardware platform. Based on this understanding, the essence of the solutions in the embodiments of the present disclosure or the part that contributes to the prior art can be embodied in the form of a software product. The computer software product may be stored in a storage medium, such as ROM/RAM, a magnetic disk, an optical disk, etc., and includes several instructions to cause a computer device (which may be a personal computer, a server, or a network device, etc.) to perform the methods described in various embodiments or certain parts of the embodiments of the present disclosure.

Finally, it should be noted that the above embodiments are only used to illustrate the solutions of the present disclosure, and not to limit them. Although the present disclosure has been described in detail with reference to the foregoing embodiments, those of ordinary skill in the art should understand that they can still modify the solutions described in the foregoing embodiments, or perform equivalent replacements on some or all of the technical features thereof. These modifications or replacements do not cause the essence of the corresponding solutions to depart from the scope of the solutions of the embodiments of the present disclosure.

For ease of explanation, the above description has been made in conjunction with specific implementations. However, the discussion of the above embodiments is not intended to be exhaustive or to limit the implementation forms to the specific forms disclosed above. Various modifications and variations are possible in light of the above teachings. The selection and description of the above implementations are to better explain the principles and practical applications, so that those skilled in the art can better use the implementations and various modified implementations suitable for specific use considerations.

What is claimed is:

1. A display device, comprising: a display, configured to display a playback picture; a memory, configured to store data associated with the display device and computer instructions; and at least one processor, configured to execute the computer instructions to cause the display device to: in response to a startup command sent by a user for displaying a first image settings page, control the display to display the first image settings page, wherein the first image settings page comprises menu items, and a display priority of the first image settings page is higher than a display priority of the playback picture; detect click events for the first image settings page; in response to a click event generated by a target menu item on the first image settings page, detect menu item parameters of the target menu item; when the menu item parameters comprise a target parameter, query a title parameter of the target menu item, wherein the target parameter is an identification parameter of a second image settings page, the second image settings page comprises a display content of the target menu item, and a display priority of the second image settings page is higher than the display priority of the playback picture; control the display to display the second image settings page in accordance with the title parameter; and modify image parameters based on the target menu item on the second image settings page.

2. The display device according to claim 1, wherein the at least one processor is further configured to execute the computer instructions to cause the display device to: detect an enabled attribute of the target menu item; in response to the target menu item being in a disabled state, control the display to display disabled prompt information, and release the click event; and in response to the target menu item being in an enabled state and the menu item parameters do not comprise the target parameter, detect a current option value of the target menu item based on the first image settings page, and modify the image parameters based on the current option value.

3. The display device according to claim 1, wherein for controlling the display to display the second image settings page in accordance with the title parameter, the at least one processor is configured to execute the computer instructions to cause the display device to: retrieve a layout file of the second image settings page; query a target position of the title parameter in the layout file; and switch menu items on the second image settings page based on the target position, to cause that the target menu item is displayed on the second image settings page.

4. The display device according to claim 3, wherein the at least one processor is further configured to execute the computer instructions to cause the display device to: configure the layout file of the second image settings page; set, in the layout file, the second image settings page to have a transparent background; and generate a menu item display region based on preset coordinate information, wherein the menu item display region is used to display the target menu item, and a background of the menu item display region is a non-transparent background.

5. The display device according to claim 4, wherein the at least one processor is further configured to execute the computer instructions to cause the display device to: detect a number of option values of the target menu item; in response to the number of option values being greater than or equal to 2, generate a prompt control of the target menu item, wherein the prompt control is used to indicate a controllable range of the target menu item; and place the prompt control in the menu item display region.

6. The display device according to claim 5, wherein for switching the menu items on the second image settings page based on the target position, the at least one processor is configured to execute the computer instructions to cause the display device to: obtain a controllable list for the target menu item, wherein the controllable list is used to record the option values of the target menu item; detect a current option value of the target menu item based on the second image settings page; in response to the current option value being at a first position or a last position in the controllable list, set a color value of the prompt control to a first value; and in response to the current option value being not at the first position and the last position in the controllable list, set the color value of the prompt control to a second value, wherein the second value is not equal to the first value.

7. The display device according to claim 4, wherein the at least one processor is further configured to execute the computer instructions to cause the display device to: receive an editing command for moving the target menu item; in response to the editing command, parse an editing key value of the editing command; and modify coordinate information of the menu item display region in accordance with the editing key value.

8. The display device according to claim 1, wherein for modifying the image parameters based on the second image settings page, the at least one processor is configured to execute the computer instructions to cause the display device to: detect a current option value of the target menu item based on the second image settings page; modify the image parameters in accordance with the current option value, and obtain a first updated layout file, wherein the first updated layout file is a layout file of a menu item associated with the second image settings page after the image parameters have been modified; and refresh the second image settings page in accordance with the first updated layout file.

9. The display device according to claim 1, wherein the at least one processor is further configured to execute the computer instructions to cause the display device to: monitor mode change events of the display device, wherein the mode change events comprise a change event of a picture mode; when a mode change event is detected, obtain a second updated layout file, wherein the second updated layout file is a layout file of a menu item associated with the second image settings page after the mode change event has been executed; and refresh the second image settings page in accordance with the second updated layout file.

10. The display device according to claim 1, wherein the display is further configured to display a target image settings page, wherein the target image settings page comprises menu items, and the target image settings page is the first image settings page or the second image settings page; and the at least one processor is further configured to execute the computer instructions to cause the display device to: in response to a first switching command input from a user based on the target menu item on the target image settings page, update a current option value of the target menu item on the target image settings page, and read a first input time of the first switching command; monitor a switching command within a first input cycle by taking the first input time as a timing starting point; in response to no second switching command being received within the first input cycle, modify the image parameters in accordance with the current option value, wherein the second switching command is a switching command with an input time later than the first input time; and in response to a second switching command being received within the first input cycle, read a second input time of the second switching command, and monitor a switching command within the first input cycle by taking the second input time as the timing starting point.

11. The display device according to claim 10, wherein the at least one processor is further configured to execute the computer instructions to cause the display device to: detect associated parameters of the target menu item on the target image settings page, wherein the associated parameters are the image parameters associated with the target menu item on the target image settings page; calculate a number of the associated parameters; and set the first input cycle in accordance with the number of the associated parameters, wherein a value of the first input cycle is directly proportional to the number of the associated parameters.

12. The display device according to claim 10, wherein for modifying the image parameters in accordance with the current option value, the at least one processor is configured to execute the computer instructions to cause the display device to: generate a parameter adjustment notification in accordance with the current option value; query a linked menu item based on the parameter adjustment notification; and the linked menu item.

13. The display device according to claim 10, wherein the at least one processor is further configured to execute the computer instructions to cause the display device to: monitor mode change events of the display device, wherein the mode change events comprise a change event of a picture mode, and the picture mode is associated with the image parameters; when a mode change event is detected, parse a target option value of the mode change event; and refresh a menu item on the target image settings page in accordance with the target option value.

14. The display device according to claim 13, wherein for refreshing the target image settings page, the at least one processor is further configured to execute the computer instructions to cause the display device to: read a state flag of the target image settings page, wherein the state flag is used to indicate an input state of a switching command; in response to the state flag being a first flag, lock the current option value of the target menu item on the target image settings page, and refresh the menu item on the target image settings page; and in response to the state flag being a second flag, refresh the current option value of the target menu item on the target image settings page and the menu item on the target image settings page.

15. The display device according to claim 14, wherein the at least one processor is further configured to execute the computer instructions to cause the display device to: monitor a switching command for the target image settings page; when the first switching command is detected, set the state flag to the first flag; and in response to no second switching command being received within a second input cycle, set the state flag to the second flag, wherein a value of the second input cycle is greater than a value of the first input cycle.

16. The display device according to claim 13, further comprising: an external device interface, configured to connect to an external device; wherein the at least one processor is further configured to execute the computer instructions to cause the display device to: in response to a plug-unplug signal generated when the external device is connected or disconnected, detect a device type of the external device; generate the mode change event in accordance with the device type; and in response to the mode change event, modify the picture mode.

17. The display device according to claim 13, wherein the at least one processor is further configured to execute the computer instructions to cause the display device to: in response to a playback signal generated when the display device plays media data, detect a media type of the media data; generate the mode change event in accordance with the media type; and in response to the mode change event, modify the picture mode.

18. The display device according to claim 10, wherein the at least one processor is further configured to execute the computer instructions to cause the display device to: obtain a controllable list for the target menu item on the target image settings page, wherein the controllable list is used to record option values of the target menu item on the target image settings page; detect the current option value of the target menu item on the target image settings page; in response to the current option value being at a first position or a last position in the controllable list, set a color value of a prompt control to a first value, wherein the prompt control is used to indicate a controllable range of the target menu item; and in response to the current option value being not at the first position and the last position in the controllable list, set the color value of the prompt control to a second value, wherein the second value is not equal to the first value.

19. A method for optimizing image settings for a display device, wherein the display device comprises a display configured to display a playback picture; and the method comprises: in response to a startup command sent by a user for displaying a first image settings page, controlling the display to display the first image settings page, wherein the first image settings page comprises menu items, and a display priority of the first image settings page is higher than a display priority of the playback picture; monitoring click events for the first image settings page; in response to a click event generated by a target menu item on the first image settings page, detecting menu item parameters of the target menu item; when the menu item parameters comprise a target parameter, querying a title parameter of the target menu item, wherein the target parameter is an identification parameter of a second image settings page, the second image settings page comprises a display content of the target menu item, and a display priority of the second image settings page is higher than the display priority of the playback picture; controlling the display to display the second image settings page in accordance with the title parameter; andmodifying image parameters based on the target menu item on the second image settings page.

20. The method according to claim 19, further comprising: detecting an enabled attribute of the target menu item; in response to the target menu item being in a disabled state, controlling the display to display disabled prompt information, and releasing the click event; and in response to the target menu item being in an enabled state and the menu item parameters do not comprise the target parameter, detecting a current option value of the target menu item based on the first image settings page, and modifying the image parameters based on the current option value.
